(19) United States
(12) Patent Application Publication
(10) Pub. No.: US 2008/0103734 A1
(43) Pub. Date: May 1, 2008

(54) Supporting apparatus, design suporting method, and cad system

(75) Inventor: Makoto Kobayashi, kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/892,804

(22) Filed: Aug. 27, 2007

(30) Foreign Application Priority Data
Nov. 1, 2006 (JP) 2006-297351

(51) Int. Cl. G06F 17/50

(52) U.S. Cl. 703/1

(57) ABSTRACT

In a design supporting apparatus, a model shape inputting unit inputs data of a model designed by a CAD. A search component type designation receiving unit receives designation of a type of a component to be searched for. An attachable space range designation receiving unit receives designation of an attachable space range on the design model. An attachable space shape creating unit creates an attachable space shape from a shape of the attachable space range and a shape of the design model. A shape searching unit extracts a component that corresponds to the component type designated and fits in the attachable space shape created from a component shape database.

### CROSS-REFERENCE TO RELATED APPLICATIONS

This application claims the conventional priority based on Japanese Application No. 2006-297351, filed on Nov. 1, 2006, the disclosures of which are incorporated herein by reference.

### BACKGROUND OF THE INVENTION

1. Field of the Invention

The present invention relates to a technique for performing design support by searching for a component designed in the past, and, more particularly to a design supporting apparatus, a design supporting method, and a CAD system for creating a shape of a component attachable space from a space designated for a model to be designed and extracting a component attachable to the design model from components created in the past according to shape search using the space shape created.

2. Description of the Related Art

In designing some model, it is necessary to also perform designing of a component attached to the design model. In designing the component, if it is possible to substitute a component designed to be attached to other models in the past for the component, time and labor for designing components anew are saved. Thus, in some cases, a substitutable component is found out from a database of components in the past and attached to a design model. When it is possible to substitute a component used in other products actually manufactured for a component to be attached to the design model, a significant effect is obtained in terms of cost of manufacturing.

As documents in which techniques related to the present invention are disclosed, there are Japanese Patent Application Laid-Open No. 2002-236711, H8-185431, and 2001-338002. Japanese Patent Application Laid-Open No. 2002-236711 discloses a technique for checking presence or absence of interference between a component to be added and a pipe already arranged in plant designing. Japanese Patent Application Laid-Open No. H8-185431 discloses a technique concerning a design supporting apparatus that can perform designing taking into account assembly by registering a manual work space in tool data and respective tools. Japanese Patent Application Laid-Open No. 2001-338002 discloses a technique for finding a similar standard component from a database based on share information of an inputted shape and attributes (a manufacturer, a price, and a material) of the shape.

However, it is impossible to solve problems described later with the techniques disclosed in these patent documents.

The method of substituting a component designed in the past for a component to be designed is very useful. However, it is not easy to find out substitutable components designed in the past from the database including data of enormous number of components. Actually, in most cases, names and serial numbers of substitutable components designed in the past are unknown. Thus, a designer has to check the names and the serial numbers by asking other designers. Nevertheless, the designer still cannot find out substitutable components and often has to design a component anew after all wasting labor and time for searching for a substitutable component.

Further, in the past, accuracy of search for a substitutable component is not so high. When a component designed in the past is substituted for a component to be designed, design mistakes occur. For example, the substituted component interferes with other components of a model to which the substituted component is attached.

Particularly, for example, when a component designed in the past is substituted for an auxiliary component for attaching a component to a design model, since a shape of a space in which the auxiliary component can be arranged is limited, it is not easy to find out a component that fits in the shape of the space.

In Japanese Patent Application Laid-Open No. 2001-338002, component search is performed by inputting a shape of a component to be searched for. However, when a designer searches for a component to be attached to a design model, the designer does not always wish to specify a shape of the component and search for the component. For example, when the designer wishes to substitute a component that is designed in the past and fits in a free space of the design model for the component to be attached to the design model, the technique for specifying a shape of a component and searching for the component disclosed in Japanese Patent Application Laid-Open No. 2001-338002 is not applicable.

### SUMMARY OF THE INVENTION

It is an object of the present invention to provide a design supporting apparatus that allows, when a user wishes to substitute a component designed in the past for a component to be attached to a design model, the user to easily find out a substitutable component that fits in a space on the design model.

It is another object of the present invention to provide a design supporting method that allows, when a user wishes to substitute a component designed in the past for a component to be attached to a design model, the user to easily find out a substitutable component that fits in a space on the design model.

It is still another object of the present invention to provide a CAD system that allows, when a user wishes to substitute a component designed in the past for a component to be attached to a design model, the user to easily find out a substitutable component that fits in a space on the design model.

The present invention provides a design supporting apparatus that receives designation of a range of a component attachable space on a design model, creates a shape of the component attachable space from the designation of the range of the component attachable space and the shape of the design model, and performs shape search using a characteristic of the shape of the component attachable space created to extract a component attachable to the design model from a database of components.

The design supporting apparatus of the present invention is the design supporting apparatus that extracts components usable in a design model designed by a CAD. The design supporting apparatus comprises a component shape database for holding data of plural components, a model inputting unit for inputting data of the design model, an attachable space range designation receiving unit for receiving designation of an attachable space range, which is a range of a component attachable space on the design model, an attachable space shape creating unit for creating an attachable space shape, which is a shape of the component attachable space, by deleting a shape of a portion interfering with the attachable space range of the design model from a shape of the attachable space range, and a shape searching unit for performing shape search in the attachable space shape to extract components that fit in the attachable space shape from the component shape database.

According to the design supporting apparatus of the present invention, it is possible to easily find out a component matching the component attachable space on the design model from components designed in the past. For example, when an auxiliary component used for attaching the component to the design model is searched for, since a shape of a space in which the auxiliary components is attachable is limited, the design supporting apparatus is particularly useful.

Preferably, the design supporting apparatus further comprises a search condition designation receiving unit for receiving designation of a search condition, which is a condition for extracting components from the component shape database. The shape searching unit performs shape search in the attachable space shape to extract components that satisfy the search condition and fit in the attachable space shape from the component shape database. The search condition is, for example, a type of a component. Since a component to be searched for is limited by the search conditions, even if data of an enormous number of components are held in the component shape database, it is possible to easily extract a component matching a purpose of use.

Preferably, in the design supporting apparatus, the attachable space range designation receiving unit receives, for a component on the design model interfering with the attachable space range, designation on whether a space of a portion of the component interfering with the attachable space range should be included in the attachable space shape. The attachable space shape creating unit does not delete, for the component on the design model, the space of the portion of which interfering with the attachable space range is designated as being included in the attachable space shape, a shape of the space of the interfering portion from the attachable space range.

According to the design supporting apparatus of the present invention, even if a component is already attached on the design model, when it is possible to change a design to place the component in another place on the design model, it is highly likely that a component that fits in the attachable space shape can be found out by designating a shape of a space, in which the component is already arranged, to be included in the attachable space shape and setting the attachable space shape large.

Preferably, the design supporting apparatus further comprises a presenting unit for presenting the components extracted by the shape searching unit, and a component selection receiving unit for receiving selection of a component used for the design model from the components extracted. According to the design supporting apparatus of the present invention, a user can select a component that is considered to be a best component from the components extracted by the shape search.

Preferably, the design supporting apparatus further comprises a result outputting unit for reflecting a result of component extraction by the shape searching unit or a result of component selection received by the component selection receiving unit on the component shape database. The component shape database has, for each component, information for managing the result of component extraction or the result of component selection. According to the design supporting apparatus of the present invention, tt is possible to improve accuracy of component search by feeding back the result of component extraction and the result of component selection to the component shape database.

Preferably, the design supporting apparatus further comprises a work space verifying unit for deleting a shape of a space of the component selected by the component selection receiving unit from the attachable space shape and verifying a work space for performing work for attaching the selected component to the design model based on the attachable space shape from which the shape of the selected component is deleted. According to the design supporting apparatus of the present invention, it is possible to prevent a design mistake such as lack of a work space for actually attaching the selected component to the model.

The design supporting method of the present invention is the design supporting method by a computer of a design supporting apparatus that includes a component shape database, which holds data of plural components, and extracts components usable in a design model designed by a CAD. The design supporting method comprises inputting, in the computer, data of the design model, receiving, in the computer, designation of an attachable space range, which is a range of a component attachable space on the design model, creating, in the computer, an attachable space shape, which is a shape of the component attachable space, by deleting a shape of a portion interfering with the attachable space range of the design model from a shape of the attachable space range, and extracting, in the computer, components that fit in the attachable space shape from the component shape database by performing shape search in the attachable space shape.

When the design supporting apparatus of the present invention is built in a CAD system, it is possible to perform designing of a model by the CAD while extracting a substitutable component designed in the past.

The CAD system of the present invention comprises a CAD processing unit for designing a model, a design support processing unit for extracting components usable in a design model, and a component shape database for holding data of plural components. The CAD processing unit comprises a design processing unit for designing a model based on input information, and a design model data storing unit for storing data of the design model designed. The design support processing unit comprises a model inputting unit for inputting data of the design model designed by the CAD processing unit, an attachable space range designation receiving unit for receiving designation of an attachable space range, which is a range of a component attachable space on the design model, an attachable space shape creating unit for creating an attachable space shape, which is a shape of the component attachable space, by deleting a shape of a portion interfering with the attachable space range of the design model from a shape of the attachable space range, and a shape searching unit for performing shape search in the attachable space shape to extract components that fit in the attachable space shape from the component shape database.

The processing by the design supporting apparatus explained above can be realized by a computer and a software program. It is also possible to record the program in a computer-readable recording medium and providing the program through a network.

According the design supporting apparatus, the design supporting method, and the CAD system of the present invention, it is possible to easily find out a component designed in the past from a database of components and substitute the component for a component to be attached to a design model and to reduce manpower for creating a model. Since components matching a characteristic of the attachable space shape are extracted, it is possible to prevent design mistakes in that the substituted component does not fit in the attachable space shape and the component interferes with other components.

Since a component is searched for by designating search conditions, it is possible to reduce the number of components, which will be search objects, by excluding components matching the characteristic of the attachable space shape but not suitable for an application from the search objects.

Even if other components are included in the designated attachable space range, when the components are movable to the outside of the attachable space range, it is possible to expand a component attachment range by creating an attachable space shape not included in the attachable space range.

When there are plural component matching the search conditions, it is possible to select and determine a component to be applied. It is possible to feed back information on a selected component to the database of component to improve accuracy of search.

It is possible to easily verify whether there is a work space for attaching the selected component from a shape obtained by deleting a shape of the selected component from the attachable space shape.

### BRIEF DESCRIPTION OF THE DRAWINGS

FIG. 1 is a diagram showing an example of a hardware environment that realizes a system of the present invention.

FIG. 2 is a diagram showing an example of a structure of a CAD system according to an embodiment of the present invention.

FIG. 3 is a diagram showing an example of a data structure of a component shape database.

FIGS. 4A to 8B are diagrams for explaining operations of processing unit of a design supporting apparatus.

FIG. 9 is a flowchart of design support processing by a design supporting apparatus according to an embodiment of the present invention.

FIG. 10 is a flowchart of attachable space shape creation processing by an attachable space shape creating unit according to an embodiment of the present invention.

FIG. 11 is a flowchart of similarity judgment processing by a shape searching unit according to an embodiment of the present invention.

FIGS. 12A to 12C are diagrams showing examples of a histogram created according to the similarity judgment processing.

FIG. 13 is a flowchart of feedback processing by a result outputting unit according to an embodiment of the present invention.

FIG. 14 is a flowchart of work space verification processing by a work space verifying unit according to an embodiment of the present invention.

### DETAILED DESCRIPTION OF THE PREFERRED EMBODIMENTS

An embodiment of the present invention will be hereinafter explained with reference to the accompanying drawings.

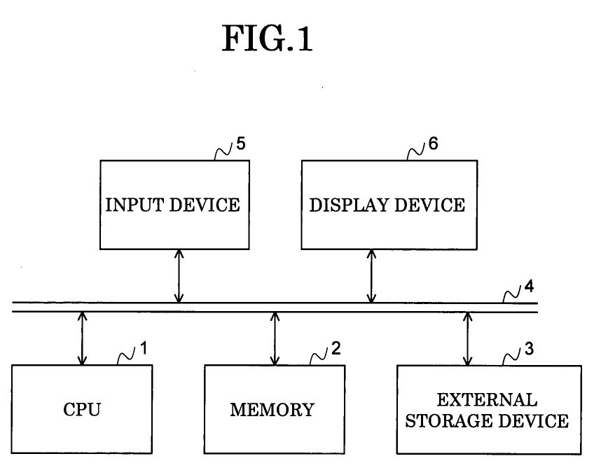

FIG. 1 is a diagram showing an example of a hardware environment that realizes a system of the present invention. The system of the present invention is realized by a computer system including a CPU 1, a memory 2, an external storage device 3, a bus 4, an input device 5, and a display device 6.

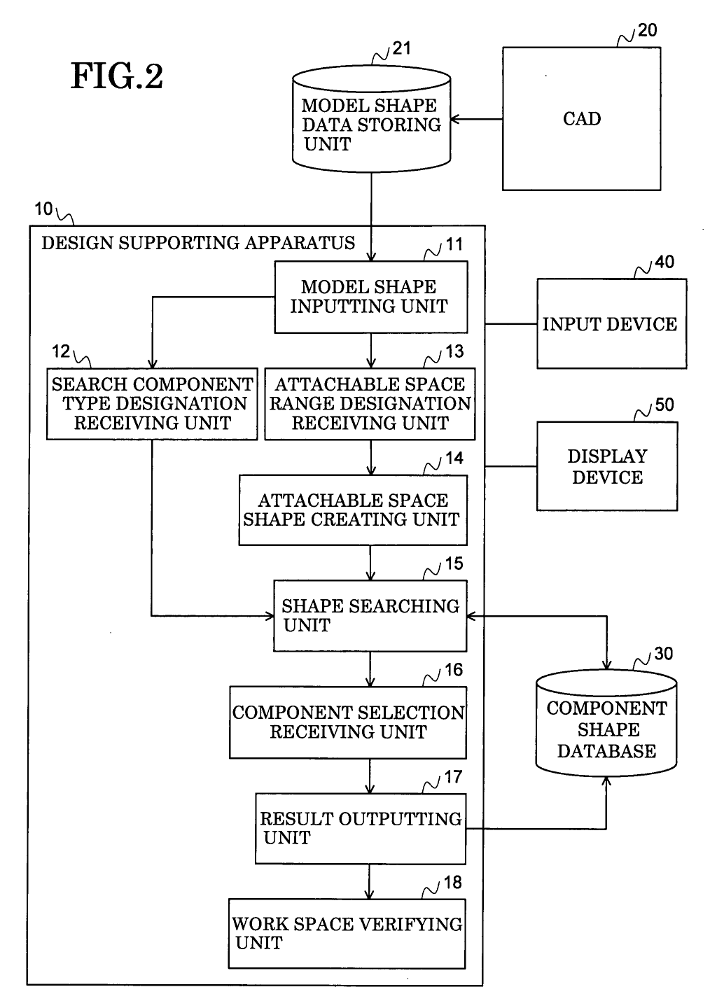

FIG. 2 is a diagram showing an example of a structure of a CAD system according to an embodiment of the present invention. The CAD system includes a design supporting apparatus 10, a CAD 20, a model shape data storing unit 21, a component shape database 30, an input device 40, and a display device 50.

A shape data of a model designed by the CAD 20 is stored in the model shape data storing unit 21. The component shape database 30 is a database in which information on components designed in the past is stored. A user operates the input device 40 to input necessary information while referring to information outputted to a screen of the display device 50.

The design supporting apparatus 10 is an apparatus that supports designing of a model by the CAD 20 by extracting a component attachable to a model from the component shape database 30 according to shape search. The design supporting apparatus 10 includes a model shape inputting unit 11, a search component type designation receiving unit 12, an attachable space range designation receiving unit 13, an attachable space shape creating unit 14, a shape searching unit 15, a component selection receiving unit 16, a result outputting unit 17, and a work space verifying unit 18.

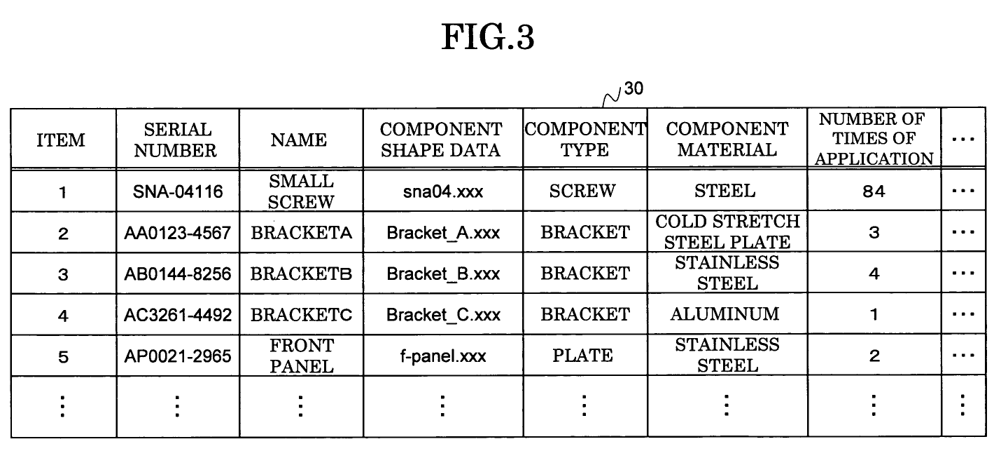

FIG. 3 is a diagram showing an example of a data structure of the component shape database 30. The component shape database 30 includes information such as an item, a serial number, a name, component shape data, a component type, a component material, and the number of times of application. The item is an identifier for uniquely identifying each record in the component shape database 30. The serial number is a product number of a component. The name is a name of the component. The component shape data is a file name of a 3D model of the component. The component type is a type of the component. The component material is a material name of the component. The number of times of application is feedback information from the design supporting apparatus 10 and is the number of times the component is selected by the user when the component is extracted by the shape search.

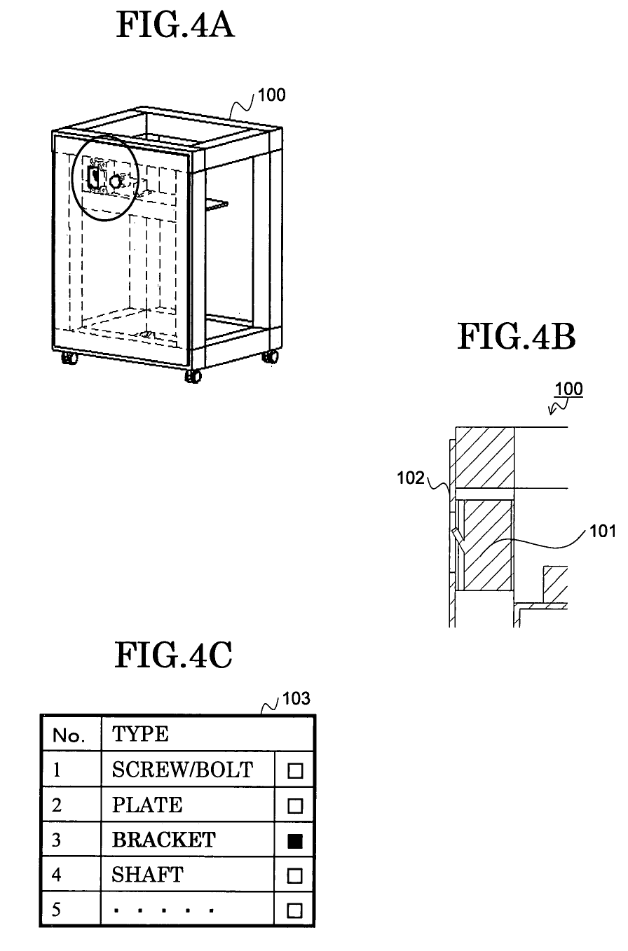

Operations of the respective processing unit in the design supporting apparatus 10 according to an embodiment of the present invention will be specifically explained using examples shown in FIGS. 4A to 8B. The examples shown in FIGS. 4A to 8B are examples of designing of a bracket for attaching a breaker.

FIGS. 4A to 4C are diagrams for explaining an embodiment of the present invention. Operations from input of a model to designation of a component type to be searched for will be explained with reference to FIGS. 4A to 4C.

The model shape inputting unit 11 inputs a model 100 (shape data of the model 100) designed by the CAD 20 from the model shape data storing unit 21. The model 100 inputted is displayed on the screen of the display device 50. It is assumed that the model 100 of a frame shown in FIG. 4A is inputted by the model shape inputting unit 11. FIG. 4B is a diagram showing a cross section of a portion surrounded by an ellipse in FIG. 4A. As shown in a cross section near a breaker 101 in FIG. 4B, at this point, a bracket for attaching the breaker 101 to a front panel 102 of the frame is not designed yet.

The search component type designation receiving unit 12 receives designation of a component type to be searched for from the user. For example, the search component type designation receiving unit 12 displays a component type list 130 shown in FIG. 4C on the screen of the display device 50 to allow the user to designate a component type to be searched for. In FIG. 4C, a bracket for attaching the breaker 101 to the front panel 102 of the frame is designated.

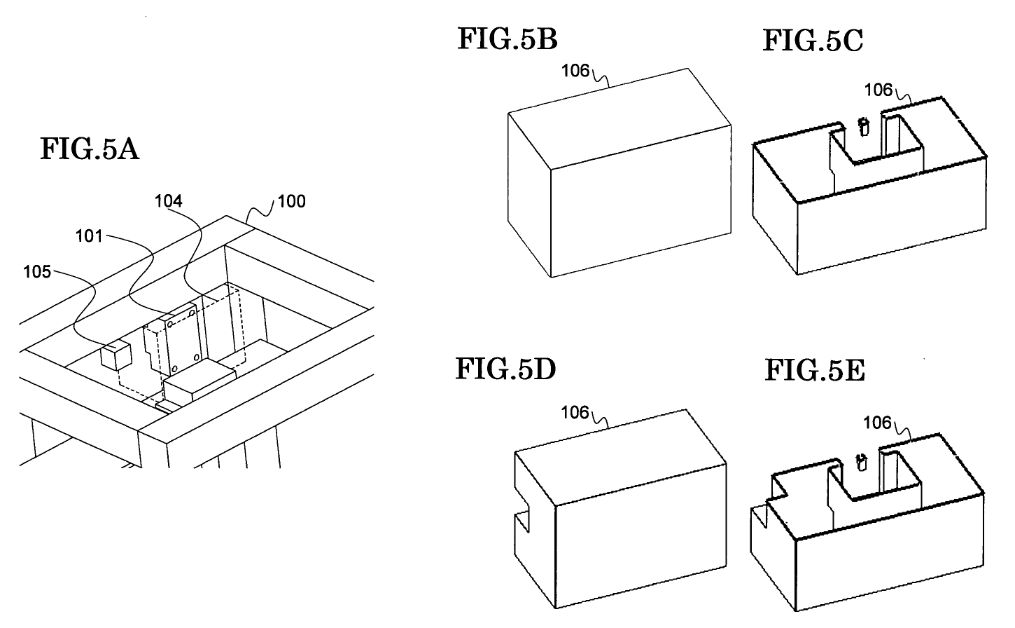

FIGS. 5A to 5E are diagrams for explaining an embodiment of the present invention. Operations from designation of an attachable space range to creation of an attachable space shape will be explained with reference to FIGS. 5A to 5E.

The attachable space range designation receiving unit 13 receives designation of an attachable space range 104 of a component on the model 100 designated from the user. As shown in FIG. 5A, the user designates the attachable space range 104, which is a range of a space in which a component searched for is attachable, on the model 100 displayed on the screen of the display device 50.

The attachable space range designation receiving unit 13 also receives designation on whether a space of a component that is in a position interfering with the attachable space range 104 designated and is already designed as a part of the model 100 should be directly included in the attachable space range 104. For example, in FIG. 5A, a part of a switch 105 interferes with the attachable space range 104 designated. In this case, when it is possible to change a design to place an attachment position of the switch 105 on the outside of the attachable space range 104 designated, a space of the attachable space range 104 is increased by including the space of the switch 105 in the attachable space range 104, namely, showing the switch 105 as if the switch 105 is not in the attachable space range 104. As a result, it is more likely that an applicable bracket is extracted by component search.

As a method of designating whether a space of a component interfering with the attachable space range 104 should be included in the attachable space range 104, for example, there is a method of setting a component interfering with the attachable space range 104 on the model 100 not to be displayed. There is also a method of selecting and designating a setting, using a menu, on whether a space of a component interfering with the attachable space range 104 should be included in the attachable space range 104.

The attachable space shape creating unit 14 is a unit for creating an attachable space shape 106 from a shape of the model 100 and the attachable space range 104 designated. A shape obtained by deleting a portion interfering with the attachable space range 104 of the model 100 from the attachable space range 104 designated is the attachable space shape 106. In this case, when there is designation on whether a space of a component of the model 100 in a position interfering with the attachable space range 104 designated should be included in the attachable space range 104, the attachable space shape creating unit 4 creates the attachable space shape 106 taking into account the designation.

FIG. 5B is the attachable space shape 106 created when the space of the switch 105 is included in the attachable space range 104. FIG. 5C is a cross section of the attachable space shape 106 shown in FIG. 5B. FIG. 5D is the attachable space shape 106 created when the space of the switch 105 is not included in the attachable space range 104. FIG. 5E is a cross section of the attachable space shape 106 shown in FIG. 5D.

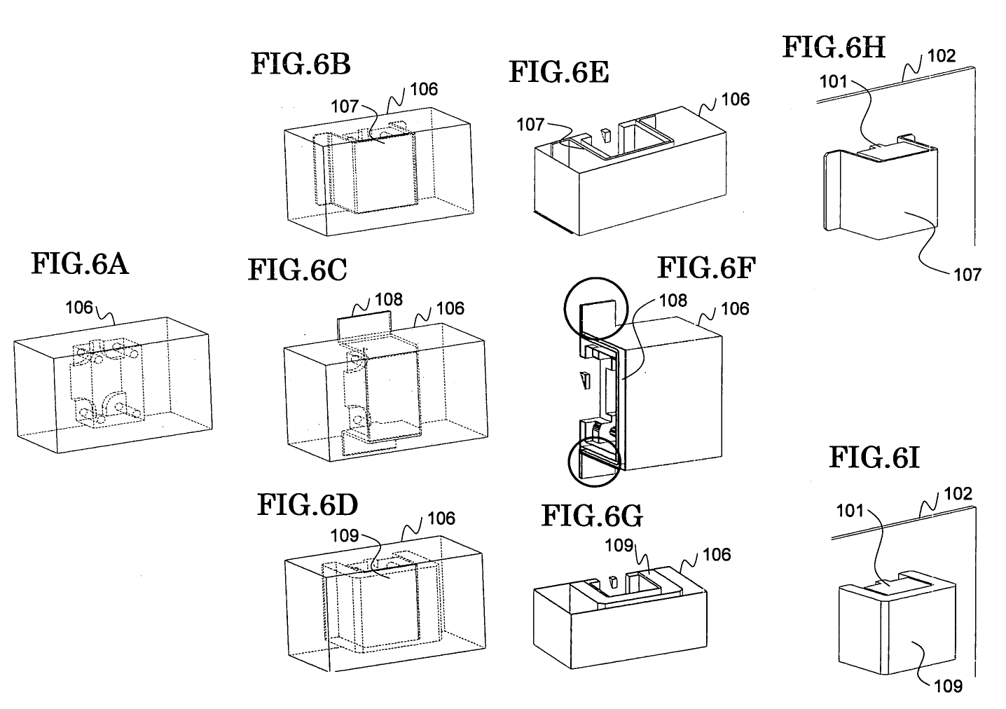

FIGS. 6A to 6I are diagrams for explaining an embodiment of the present invention. Operations from search for a component to selection of the component will be explained with reference to FIGS. 6A to 6I.

The shape searching unit 15 extracts components that fit in the attachable space shape 106 created and correspond to a component type designated from the component shape database 30 according to shape search. The components extracted are arranged and displayed on the display device 50 as candidates of a component to be adopted. In this case, the shape searching unit 15 may extract the number of times of application of the extracted components from the component shape database 30 and arranges the components in order from one having the largest number of times of application.

FIG. 6A is the attachable space shape 106 shown in FIG. 5B as well. The attachable space shape 106 is created when it is designated to include the space of the switch 105 in the attachable space range 104 when the attachable space range 104 is designated. The shape searching unit 15 extracts components from the component shape database 30 according to the shape search using the attachable space shape 106 and the component type (the bracket) designated in the component type list 103 in FIG. 4C.

First, the shape searching unit 15 detects components, a component type of which is a bracket and component shapes of which are similar to the attachable space shape 106 shown in FIG. 6A. Here, as shown in FIGS. 6B, 6C, and 6D, brackets A107, a bracket B108, and a bracket C109 are detected as brackets, component types of which are similar to the attachable space shape 106 in FIG. 6A.

The shape searching unit 15 selects components (brackets) that fit in the attachable space shape 106 as a result of the shape search. FIG. 6E is a cross section of the bracket A107, FIG. 6F is a cross section of the bracket B108, and FIG. 6G is a cross section of the bracket C109. Circles in FIG. 6F show parts that stick out from the attachable space shape 106. Since the parts of the bracket B108 stick out from the attachable space shape 106 in FIG. 6A, the bracket B108 is not selected. As a result of the shape search, the bracket A107 and the bracket C109 that fit in the attachable space shape 106 are selected as a result of the shape search.

The brackets A107 and C109 extracted from the component shape database 30 are presented to the user as candidates of a bracket for attaching the breaker 101 to the frame. Here, as shown in FIGS. 6H and 6I, the brackets C107 and C109 are presented in a state in which the breaker 101 is attached to the front panel 102.

The component selection receiving unit 16 receives an input of component selection by the user. The user selects a component to be adopted from the candidates of the component presented on the screen of the display device 50. Here, the bracket A107 shown in FIG. 6H is selected.

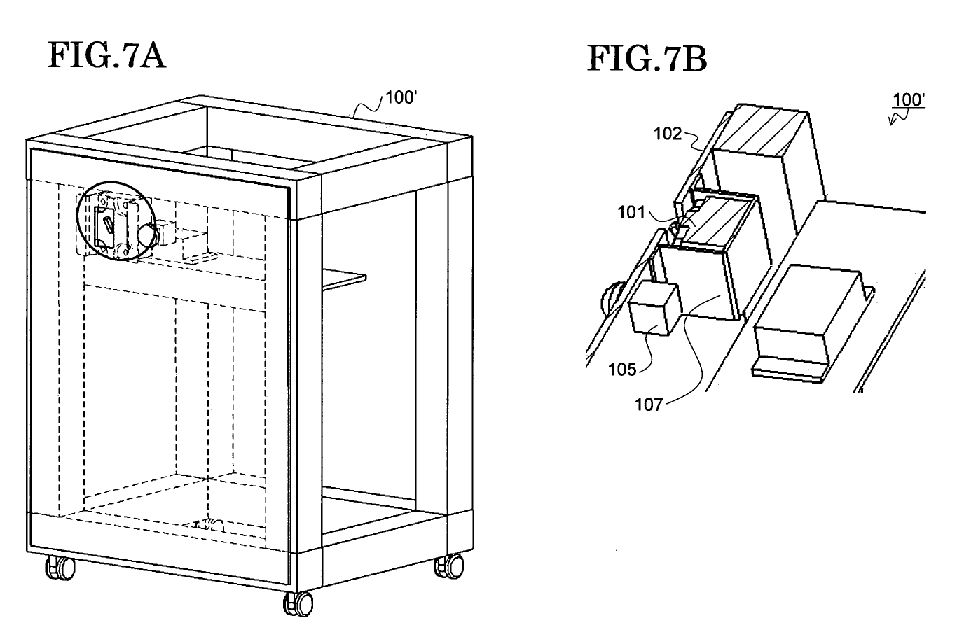

FIGS. 7A and 7B are diagrams for explaining an embodiment of the present invention. An operation for outputting a component selection result will be explained with reference to FIGS. 7A and 7B.

The result outputting unit 17 displays a result of component selection by the user on the display device 50. Here, as shown in FIG. 7A, a model 100′ attached with the bracket A107 extracted from the component shape database 30 by the shape search and selected by the user is displayed on the display device 50. FIG. 7B is a diagram showing a cross section of a portion surrounded by an ellipse in FIG. 7A. As shown in a cross section near the breaker 101 in FIG. 7B, the breaker 101 is attached to the front panel 102 using the bracket A107.

The result outputting unit 17 feeds back the result of the component selection by the user to the component shape database 30. When the bracket A107 is selected, the result outputting unit 17 detects a record of the bracket A107 from the component shape database 30 shown in FIG. 3 and increments the number of times of application of the record. Here, the number of times of application of the record of the bracket A107 in the component shape database 30 shown in FIG. 3 is updated from 3 to 4.

As a method of feeding back the result to the component shape database 30, various methods are conceivable. For example, when importance is attached to a rate of adoption of a component by the user, in the component shape database 30, information on the number of times the component is extracted by the shape search and information on the number of times the component is selected as a component to be adopted by the user are set as feedback information for each record instead of the information on the number of times of application. Every time the component is detected by the shape search and every time the component is selected as a component to be adopted by the user, results of the detection and the selection may be fed back to the component shape database 30.

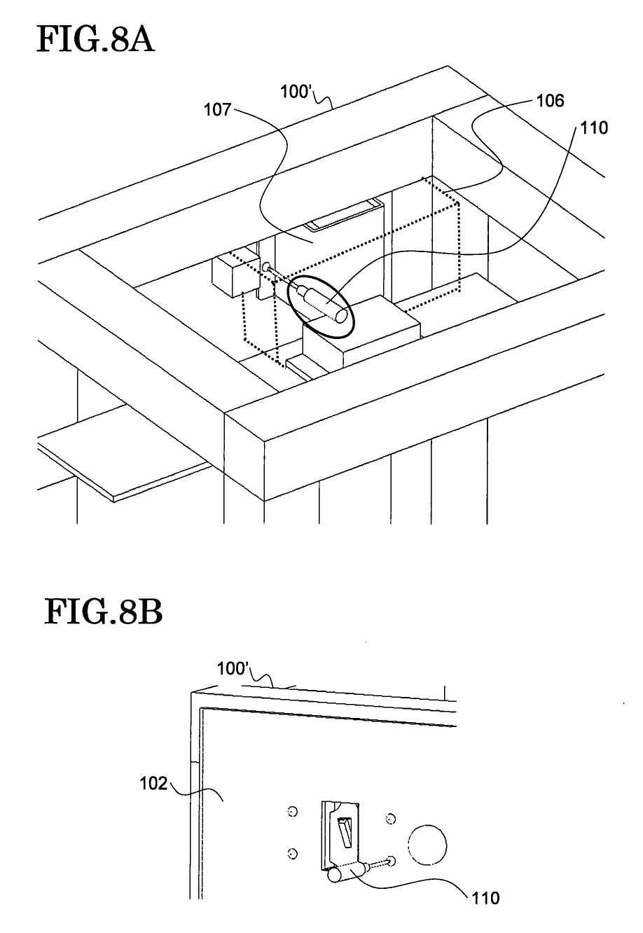

FIGS. 8A and 8B are diagrams for explaining an embodiment of the present invention. An operation of verification of a work space for attaching an adopted component will be explained with reference to FIGS. 8A and 8B.

Even if the bracket A107 is adopted as a component for attaching the breaker 101 to the front panel 102, this is meaningless in case there is no work space for attaching the bracket A107. To prevent such a design mistake, the work space verifying unit 18 performs verification of a work space for attaching an adopted component.

First, the work space verifying unit 18 removes an attachment space for the bracket A107 adopted from the attachable space shape 106. The work space verifying unit 18 receives designation of a position where the bracket A107 is fastened to the front panel 102 from the user. When a fastening position is set in the bracket A107 in advance, it is possible to omit this procedure. The work space verifying unit 18 receives designation of a tool 110 used for attaching the bracket A107. Shape data of the tool 110 designated by the user is stored in a tool database (not shown) together with operation information of the tool 110. The operation information of the tool 110 is information on an operation at the time when the tool 110 is used, for example, in the case of a driver, rotation around a shaft of the drive in use. It is assumed that human fingers are included in the tool 110.

As shown in FIG. 8A, the work space verifying unit 18 arranges the designated tool 110 in the designated fastening position of the bracket A107 on the model 100′ attached with the bracket A107 and causes the tool 110 arranged to operate according to the operation information of the tool 110. When the tool 110 does not stick out from the attachable space shape 106 from which the attachment space for the bracket A107 is removed, the work space verifying unit 18 presents an indication that it is possible to attach the bracket A107 to the user as a verification result. When the tool 110 sticks out from the attachable space shape 106 from which the attachment space for the bracket A107 is removed, the work space verifying unit 18 presents an indication that it is impossible to attach the bracket A107 to the user as a verification result. In the case of FIG. 8A, as indicated by the portion surrounded by an ellipse, since the tool 110 sticks out from the attachable space shape 106 from which the attachment space for the bracket A107 is removed, the work space verification unit 18 presents an indication that it is impossible to attach the bracket A107 to the user as a verification result.

After receiving the presentation of the verification result, the user can perform verification again by changing the designation of the fastening position of the bracket A107 and the designation of the tool 110 used for attaching the bracket A107. In FIG. 8B, the fastening position of the bracket A107 is changed to the front panel 102 side. When verification of an attachment work space is performed in the state shown in FIG. 8B, the tool 110 sticks out from the attachable space shape 106 from which the attachment space for the bracket A107 is removed. However, here, since the tool 110 is in an external space of the model 100′, it is judged that there is no problem.

At the time of verification of a work space, designation of the attachable space range 104 may be received from the user again to create the attachable space shape 106 from which the attachment space for the bracket A107 is removed. When a verification result indicates that it is impossible to attach the bracket 107, designation of the attachable space range 104 may be received from the user again to create the attachable space shape 106 from which the attachment space for the bracket A107 is removed and perform verification of a work space again.

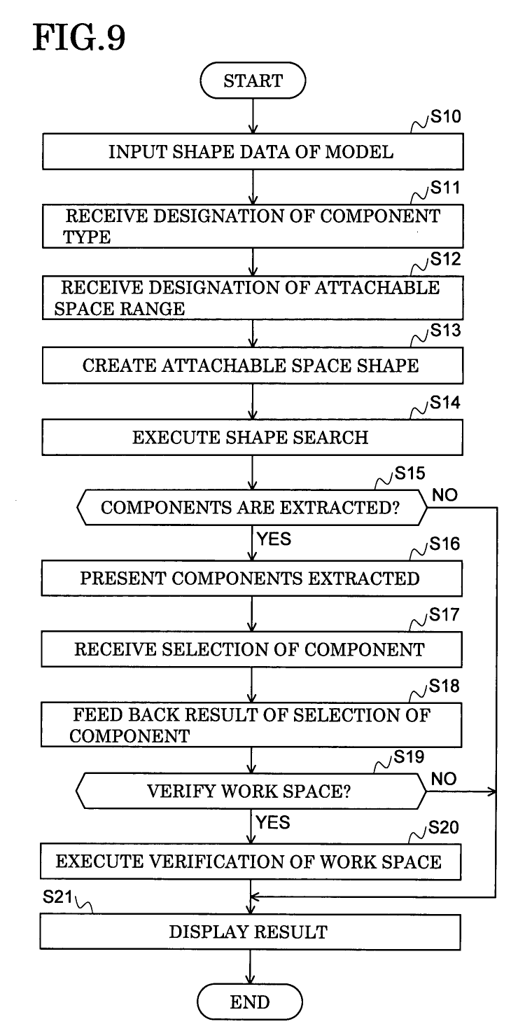

A flow of design support processing by the design supporting apparatus 10 according to an embodiment of the present invention will be explained with reference to FIGS. 9 to 14.

FIG. 9 is a flowchart of design support processing by the design supporting apparatus according to an embodiment of the present invention. First, the model shape inputting unit 11 inputs shape data of the model 100 (step S10). The search component type designation receiving unit 12 receives designation of a component type by the user (step S11). The attachable space range designation receiving unit 13 receives designation of the attachable space range 104 by the user (step S12). In this case, when it is designated whether a space of a component interfering with the attachable space range 104 designated should be included in the attachable space range 104, the attachable space range designation receiving unit 13 also receives the designation.

The attachable space shape creating unit 14 creates the attachable space shape 106 based on a shape of the model 100 inputted and a shape of the attachable space range 104 designated (step S13). When there is designation on whether the space of the component interfering with the attachable space range 104 designated should be included in the attachable space range 104, the attachable space shape 106 is created taking into account the designation.

The shape searching unit 15 executes the shape search (step S14) to extract components that fit in the attachable space shape 106 created and correspond to the component type designated from the component shape database 30. As a method of extracting components according to the shape search, for example, there is a method of judging, for components corresponding to the designated component type in the component shape database 30, whether shapes of the components are similar to the attachable space shape 106 according to techniques such as a shape distribution method, a slice base method, and a spherical harmonic method, and extracting components that fit in the attachable space shape 106 among the components judged as similar.

When there are components extracted by the shape search (step S15), the shape searching unit 15 displays the components on the display device 50 to present the components extracted to the user as candidates of components to be adopted (step S16). The component selection receiving unit 16 receives selection of a component to be adopted by the user (step S17). The result outputting unit 17 feeds back (reflects) a result of selection of a component by the user to the component shape database 30 (step S18).

When the work space verifying unit 18 determines to verify an attachment work space for the component (step S19), the work space verifying unit 18 performs verification of the attachment work space for the component (step S20).

Finally, the result outputting unit 17 displays a result of the design support processing on the display device 50 (step S21).

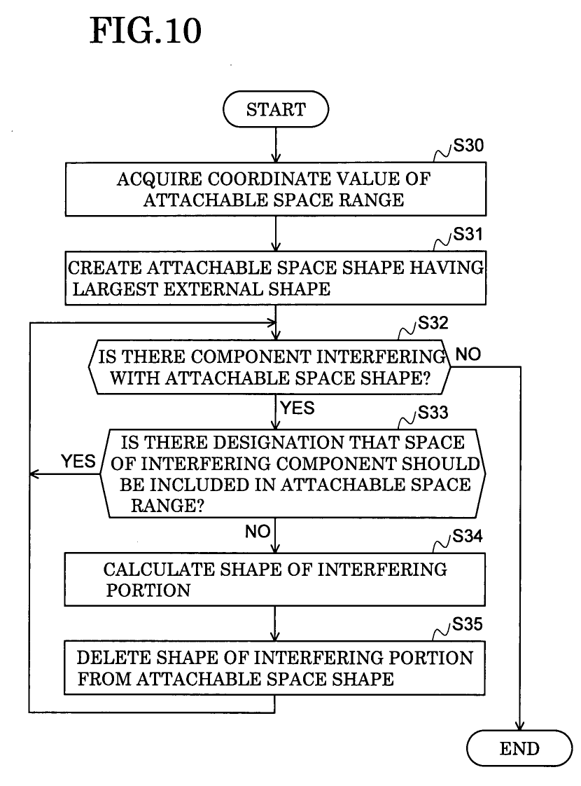

FIG. 10 is a flowchart of attachable space shape creation processing by the attachable space shape creating unit according to an embodiment of the present invention. First, the attachable space shape creating unit 14 acquires a coordinate value of the attachable space range 104 designated (step S30). Here, the attachable space shape creating unit 14 acquires a coordinate value of a largest external shape for creating the attachable space shape 106. The attachable space shape creating unit 14 creates the attachable space shape 106 having the largest external shape from the coordinate value acquired (step S31).

The attachable space shape creating unit 14 checks whether there is a component interfering with the attachable space shape 106 created among components of the model 100 (step S32). When there is no component interfering with the attachable space shape 106, the attachable space shape creating unit 14 finishes the processing.

When there is a component interfering with the attachable space shape 10, the attachable space shape creating unit 14 checks whether there is designation that a space of the interfering component should be included in the attachable space range 104 (step S33). When there is the destination that the space of the interfering component should be included in the attachable space range 104, the attachable space shape creating unit 14 returns to the step S32 and checks whether there are other components interfering with the attachable space shape 106. The judgment in step S33 is made unnecessary when it is designated whether a space of the interfering component should be included in the attachable space range 104 by setting a component interfering with the attachable space range 104 not to be displayed on the model 100.

When there is no designation that the space of the interfering component should be included in the attachable space range 104, the attachable space shape creating unit 14 calculates a shape of a portion interfering with the attachable space shape 106 of the component (step S34) and deletes the shape of the interfering portion calculated from the attachable space shape 106 (step S35). The attachable space shape creating unit 14 returns to the step S32 and checks whether there are other components interfering with the attachable space shape 106.

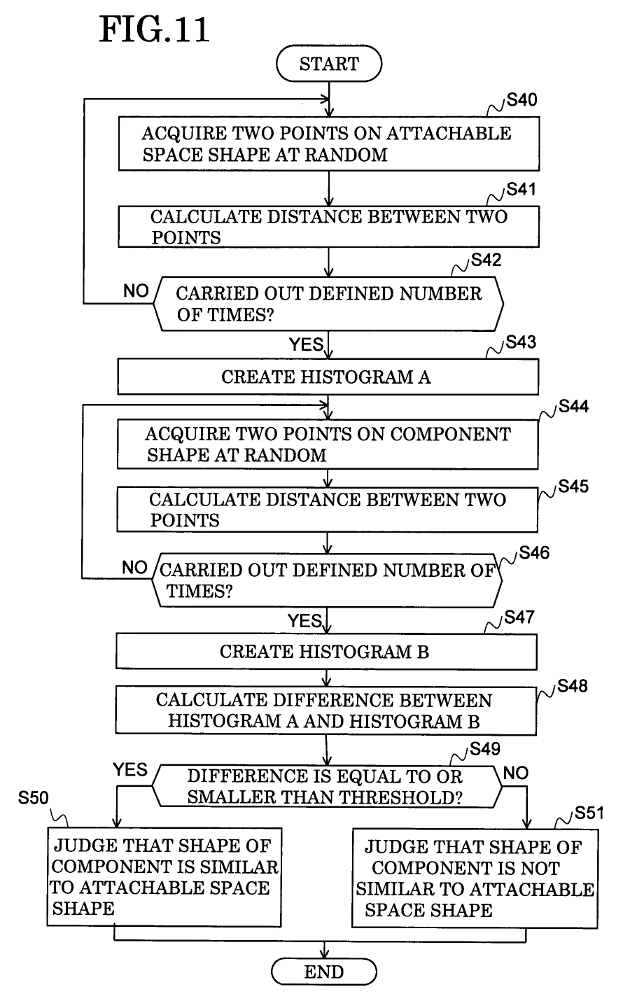

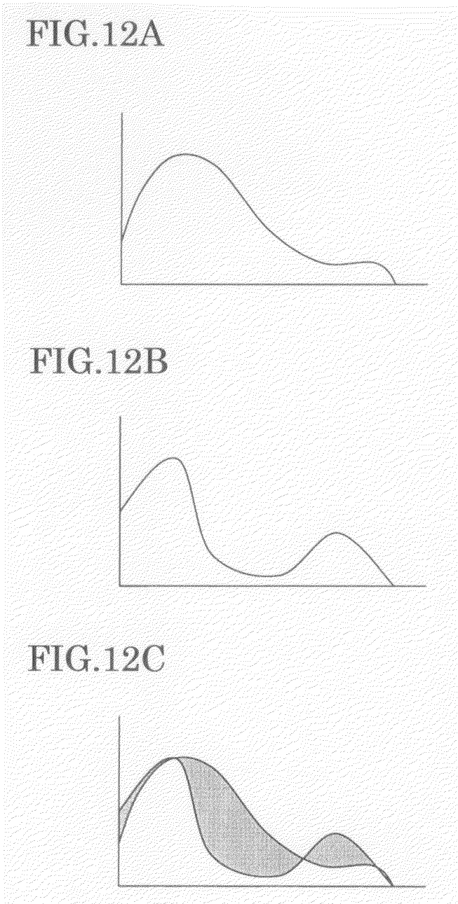

FIG. 11 is a flowchart of similarity judgment processing by the shape searching unit according to an embodiment of the present invention. FIGS. 12A to 12C are diagrams showing examples of a histogram created by the similarity judgment processing. The shape searching unit 15 judges, for each component in the component shape database 30 corresponding to a designated component type, whether a shape of the component is similar to the attachable space shape 106 created. Here, an example of the shape distribution method will be explained.

First, the shape searching unit 15 acquires two points on the created attachable space shape 106 created at random (step S40) and calculates a distance between the two points acquired (step S41). The shape searching unit 15 carries out the processing in the steps S40 and S41 a defined number of times (step S42) and creates a histogram A from distance data obtained (step S43). Here, it is assumed that a histogram shown in FIG. 12A is obtained as the histogram A.

The shape searching unit 15 acquires two points on a component shape of a component in the component shape database 30, for which similarity judgment is performed, at random (step S44) and calculates a distance between the two points acquired (step S45). The shape searching unit 15 carries out the processing in the steps S44 and S45 a defined number of times (step S46) and creates a histogram B from distance data obtained (step S47). Here, it is assumed that a histogram shown in FIG. 12B is obtained as the histogram B.

The shape searching unit 15 calculates a difference between the histogram A and the histogram B (step S48). In FIG. 12C, a painted portion is a portion of the difference between the histogram A and the histogram B. When the difference between the histogram A and the histogram B is equal to or smaller than a predetermined threshold (step S49), the shape searching unit 15 judges that the shape of the component is similar to the attachable space shape 106 (step S50). When the difference between the histogram A and the histogram B exceeds the predetermined threshold (step S49), the searching unit 15 judges that the shape of the component is not similar to the attachable space shape 106 (step S51).

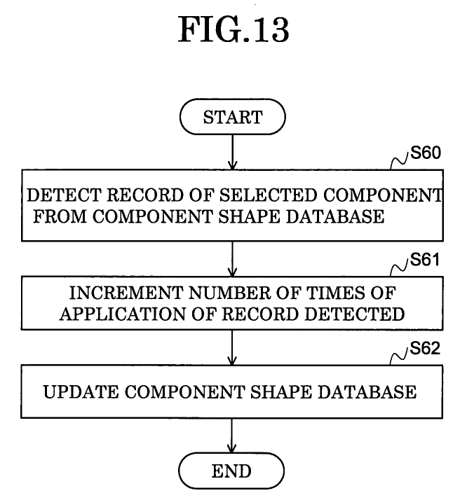

FIG. 13 is a flowchart of feedback processing by the result outputting unit according to an embodiment of the present invention. The result outputting unit 17 searches through the component shape database 30 and detects a record of a component selected by the user as a component to be adopted (step S60). The result outputting unit 17 increments the number of times of application of the record detected (step S61) and updates the component shape database 30 (step S62).

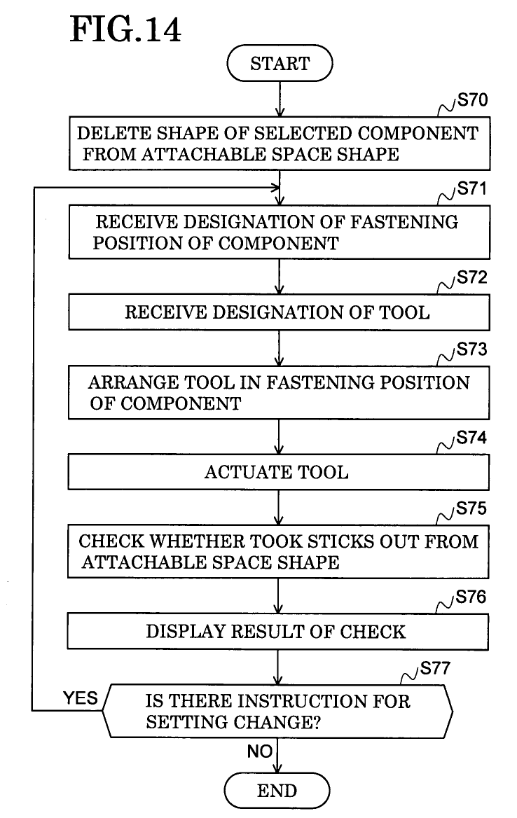

FIG. 14 is a flowchart of work space verification processing by the work space verifying unit according to an embodiment of the present invention. First, the work space verifying unit 18 deletes a shape of a component adopted by the component selection receiving unit 16 from the attachable space shape 106 created by the attachable space shape creating unit 14 (step S70). The work space verifying unit 18 receives designation of a fastening position of the component by the user (step S7 1) and receives designation of the tool 110 used for attaching the component (step S72).

The work space verifying unit 18 arranges the tool 110 designated in the fastening position of the component designated (step S73) and actuates the tool 110 based on operation information of the tool set in advance (step S74). The work space verifying unit 18 arranges the tool 110 and checks whether the tool 110 sticks out from the attachable space shape 106 as a result of the actuation (step S75). The work space verifying unit 18 displays a result of the check on the display device 50 (step S76).

When there is an instruction for a setting change from the user (step S77), the work space verifying unit 18 returns to the step S71, receives designation of a fastening position, the tool 110 and so on, and performs verification of a work space again. When there is no instruction for a setting change from the user (step S77), the work space verifying unit 18 finishes the processing.

The embodiment of the present invention has been explained. However, the present invention is not limited to the embodiment. For example, in the embodiment, components to be extracted from the component shape database 30 are limited by the search component type designation receiving unit 12. However, it is also possible to provide a search condition designation receiving unit that receives designation of various search conditions such as a component material and the number of times of application and designate various search conditions to limit components to be extracted.

For example, in the embodiment, the respective designation receiving units of the design supporting apparatus 10 receive designation from the user. However, the designation receiving units may receive designation from other apparatuses and processing units.

What is claimed is:

1. A design supporting apparatus that extracts components usable in a design model designed by a CAD, comprising:
a component shape database for holding data of plural components;
a model inputting unit for inputting data of the design model;
an attachable space range designation receiving unit for receiving designation of an attachable space range, which is a range of a component attachable space on the design model;
an attachable space shape creating unit for creating an attachable space shape, which is a shape of the component attachable space, by deleting a shape of a portion interfering with the attachable space range of the design model from a shape of the attachable space range; and
a shape searching unit for performing shape search in the attachable space shape to extract components that fit in the attachable space shape from the component shape database.

2. The design supporting apparatus according to claim 1, further comprising:
a search condition designation receiving unit for receiving designation of a search condition, which is a condition for extracting components from the component shape database,
wherein the shape searching unit performs shape search in the attachable space shape to extract components that satisfy the search condition and fit in the attachable space shape from the component shape database.

3. The design supporting apparatus according to claim 2, wherein the search condition is a type of a component.

4. The design supporting apparatus according to claim 1,
wherein the attachable space range designation receiving unit receives, for a component on the design model interfering with the attachable space range, designation on whether a space of a portion of the component interfering with the attachable space range should be included in the attachable space shape, and
wherein the attachable space shape creating unit does not delete, for the component on the design model, the space of the portion of which interfering with the attachable space range is designated as being included in the attachable space shape, a shape of the space of the interfering portion from the attachable space range.

5. The design supporting apparatus according to claim 1, further comprising:
a presenting unit for presenting the components extracted by the shape searching unit; and
a component selection receiving unit for receiving selection of a component used for the design model from the components extracted.

6. The design supporting apparatus according to claim 5, further comprising:
a result outputting unit for reflecting a result of component extraction by the shape searching unit or a result of component selection received by the component selection receiving unit on the component shape database,
wherein the component shape database has, for each component, information for managing the result of component extraction or the result of component selection.

7. The design supporting apparatus according to claim 5, further comprising:
a work space verifying unit for deleting a shape of a space of the component selected by the component selection receiving unit from the attachable space shape and verifying a work space for performing work for attaching the selected component to the design model based on the attachable space shape from which the shape of the selected component is deleted.

8. A design supporting method by a computer of a design supporting apparatus that includes a component shape database, which holds data of plural components, and extracts components usable in a design model designed by a CAD, comprising:
inputting, in the computer, data of the design model;
receiving, in the computer, designation of an attachable space range, which is a range of a component attachable space on the design model;
creating, in the computer, an attachable space shape, which is a shape of the component attachable space, by deleting a shape of a portion interfering with the attachable space range of the design model from a shape of the attachable space range; and
extracting, in the computer, components that fit in the attachable space shape from the component shape database by performing shape search in the attachable space shape.

9. The design supporting method according to claim 8, further comprising:
receiving, in the computer, designation of a search condition, which is a condition for extracting components from the component shape database,
wherein, in extracting the components, the computer performs shape search in the attachable space shape to extract components that satisfy the search condition and fit in the attachable space shape from the component shape database.

10. The design supporting method according to claim 9, wherein the search condition is a type of a component.

11. The design supporting method according to claim 8,
wherein, in receiving designation of an attachable spaced range, the computer receives, for a component on the design model interfering with the attachable space range, designation on whether a space of a portion of the component interfering with the attachable space range should be included in the attachable space shape, and
wherein, in creating an attachable space shape, the computer does not delete, for the component on the design model, the space of the portion of which interfering with the attachable space range is designated as being included in the attachable space shape, a shape of the space of the interfering portion from the attachable space range.

12. The design supporting method according to claim 8, further comprising:
presenting, in the computer, the components extracted in extracting components; and
receiving, in the computer, selection of a component used for the design model from the components extracted.

13. The design supporting method according to claim 12,
wherein the component shape database has, for each component, information for managing a result of component extraction or a result of component selection, and
wherein the computer reflects the result of component extraction in extracting the components or the result of component selection received in receiving selection of the component on the component shape database.

14. The design supporting method according to claim 12, further comprising:
deleting, in the computer, a shape of a space of the component selected in receiving selection of the component from the attachable space shape and verifying a work space for performing work for attaching the selected component to the design model based on the attachable space shape from which the shape of the selected component is deleted.

15. A CAD system comprising:
a CAD processing unit for designing a model;
a design support processing unit for extracting components usable in a design model; and
a component shape database for holding data of plural components,
wherein the CAD processing unit comprises:
a design processing unit for designing a model based on input information, and
a design model data storing unit for storing data of the design model designed, and
wherein the design support processing unit comprises:
a model inputting unit for inputting data of the design model designed by the CAD processing unit,
an attachable space range designation receiving unit for receiving designation of an attachable space range, which is a range of a component attachable space on the design model,
an attachable space shape creating unit for creating an attachable space shape, which is a shape of the component attachable space, by deleting a shape of a portion interfering with the attachable space range of the design model from a shape of the attachable space range, and
a shape searching unit for performing shape search in the attachable space shape to extract components that fit in the attachable space shape from the component shape database.

16. The CAD system according to claim 15,
wherein the design support processing unit further comprises:
a search condition designation receiving unit for receiving designation of a search condition, which is a condition for extracting components from the component shape database, and
wherein the shape searching unit performs shape search in the attachable space shape to extract components that satisfy the search condition and fit in the attachable space shape from the component shape database.

17. The CAD system according to claim 15,
wherein the attachable space range designation receiving unit receives, for a component on the design model interfering with the attachable space range, designation on whether a space of a portion of the component interfering with the attachable space range should be included in the attachable space shape, and
wherein the attachable space shape creating unit does not delete, for the component on the design model, the space of the portion of which interfering with the attachable space range is designated as being included in the attachable space shape, a shape of the space of the interfering portion from the attachable space range.

18. The CAD system according to claim 15, wherein the design support processing unit further comprises:
a presenting unit for presenting the components extracted by the shape searching unit, and
a component selection receiving unit for receiving selection of a component used for the design model from the components extracted.

19. The CAD system according to claim 18,
wherein the design support processing unit further comprises:
a result outputting unit for reflecting a result of component extraction by the shape searching unit or a result of component selection received by the component selection receiving unit on the component shape database,
wherein the component shape database has, for each component, information for managing the result of component extraction or the result of component selection.

20. The CAD system according to claim 18, wherein the design support processing unit further comprises:
a work space verifying unit for deleting a shape of a space of the component selected by the component selection receiving unit from the attachable space shape and verifying a work space for performing work for attaching the selected component to the design model based on the attachable space shape from which the shape of the selected component is deleted.
